(19) United States
(12) Patent Application Publication
(10) Pub. No.: US 2016/0380861 A1
(43) Pub. Date: Dec. 29, 2016

(54) METHOD FOR ORDERING MONITORED PACKETS WITH TIGHTLY-COUPLED PROCESSING ELEMENTS

(71) Applicant: Tektronix, Inc., Beaverton, OR (US)

(72) Inventors: Syed Muntaqa Ali, Richardson, TX (US); John Peter Curtin, Richardson, TX (US); Daniel Hill, Murphy, TX (US); Vignesh Janakiraman, Plano, TX (US)

(21) Appl. No.: 14/747,867

(22) Filed: Jun. 23, 2015

(51) Int. Cl. H04L 12/26; H04L 29/08

(52) U.S. Cl. CPC H04L 43/0876; H04L 67/14; H04L 67/10; H04L 69/322

(57) ABSTRACT

Transaction and session processing of packets within a network monitoring system may be distributed among tightly-coupled processing elements by marking each received packet with a time-ordering sequence reference. The marked packets are distributed among processing elements by any suitable process for transaction processing by the respective processing element to produce transaction metadata. Where a session-owning one of the processing elements has indicated ownership of the session to the remaining processing elements, the transaction-processed packet and transaction metadata are forwarded to the session owner. The session owner aggregates transaction-processed packets for the session, time-orders the aggregated packets, and performs session processing on the aggregated, time-ordered transaction-processed packets to generate session metadata with the benefit of context information. Where the session owner for a transaction-processed packet has not previously been indicated, the transaction-processed packet and transaction metadata are forwarded to an ordering authority of last resort, which assigns ownership of the session.

### TECHNICAL FIELD

The present disclosure relates generally to distributed processing in network monitoring systems and, more specifically, to distribution of both transaction-level and session-level processing.

### BACKGROUND

Network monitoring systems may utilize distributed processing to extract metadata from protocol data units or packets obtained from the monitored network. However, such distributed processing can conflict with the inherent transaction ordering of protocols employed by the networks monitored. Moreover, in at least some instances, the metadata desired may not be extracted from single, atomic transactions between network nodes or endpoints, but may instead require context that can only be ascertained from the complete series of transactions forming a session between the nodes and/or endpoints.

### SUMMARY

Transaction and session processing of packets within a network monitoring system may be distributed among tightly-coupled processing elements by marking each received packet with a time-ordering sequence reference. The marked packets are distributed among processing elements by any suitable process for transaction processing by the respective processing element to produce transaction metadata. Where a session-owning one of the processing elements has indicated ownership of the session to the remaining processing elements, the transaction-processed packet and transaction metadata are forwarded to the session owner. The session owner aggregates transaction-processed packets for the session, time-orders the aggregated packets, and performs session processing on the aggregated, time-ordered transaction-processed packets to generate session metadata with the benefit of context information. Where the session owner for a transaction-processed packet has not previously been indicated, the transaction-processed packet and transaction metadata are forwarded to an ordering authority of last resort, which assigns ownership of the session.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term is inclusive, meaning “and/or”; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; “circuits” refers to physical electrical and/or electronic circuits that are physically configured in full or both physically configured in part and programmably configured in part to perform a corresponding operation or function; “module,” in the context of software, refers to physical processing resources programmably configured by software to perform a corresponding operation or function; and the term “controller” means any device, system or part thereof that controls at least one operation, where such a device, system or part may be implemented in hardware that is programmable by firmware and/or software. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description, taken in conjunction with the accompanying drawings, in which like reference numerals represent like parts:

FIG. 1 is a high level diagram of a network monitoring environment within which distributed processing and ordering of monitored packets with tightly-coupled processing elements may be performed according to embodiments of the present disclosure;

FIG. 2 is a high level diagram for an example of a network monitoring system employed as part of the network monitoring environment of FIG. 1;

FIG. 3 is a high level diagram for an example of a network monitoring probe within the network monitoring system of FIG. 2;

FIG. 4 is a diagram of an exemplary 3GPP SAE network for which the network monitoring system of FIGS. 1 and 2 may be deployed according to some embodiments of the present disclosure;

FIG. 5 is a high level diagram for an example of a portion of a network where the network monitoring system of FIGS. 1 and 2 may be deployed according to some embodiments of the present disclosure;

FIG. 6 is a diagram illustrating a monitoring model employed for distributed processing and ordering of monitored packets with tightly-coupled processing elements within the network monitoring system of FIGS. 1 and 2 according to embodiments of the present disclosure;

FIG. 7A is a timing diagram and FIGS. 7B and 7C are portions of flowcharts illustrating operation of the network monitoring system of FIGS. 1 and 2 during distributed processing and ordering of monitored packets with established session ownership using tightly-coupled processing elements according to embodiments of the present disclosure;

FIG. 8A is a timing diagram and FIGS. 8B, 8C and 8D are portions of flowcharts illustrating operation of the network monitoring system of FIGS. 1 and 2 during distributed processing and ordering of monitored packets with unknown session ownership using tightly-coupled processing elements according to embodiments of the present disclosure;

FIG. 9 is a counterpart timing diagram to FIG. 7A in a network employing the GPRS tunneling protocol;

FIG. 10 is a counterpart timing diagram to FIG. 7A in a network employing the Session Initiation Protocol;

FIG. 11 is a portion of a flowchart illustrating operation of the network monitoring system of FIGS. 1 and 2 during distributed transaction-processing and session-processing of monitored packets using tightly-coupled processing elements according to embodiments of the present disclosure; and

FIG. 12 is a block diagram of an example of a data processing system that may be configured to implement the systems and methods, or portions of the systems and methods, described in the preceding figures.

### DETAILED DESCRIPTION

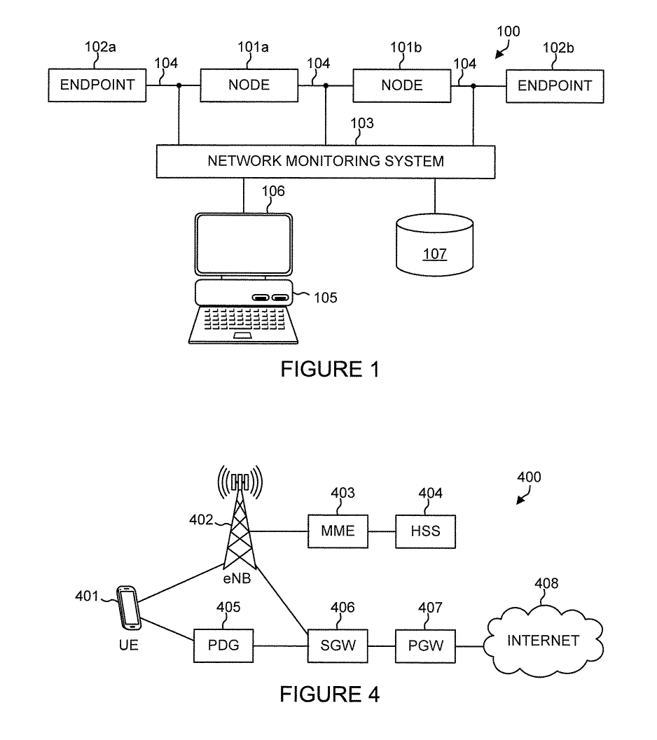

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

FIG. 1 is a high level diagram of a network monitoring environment within which distributed processing and ordering of monitored packets with tightly-coupled processing elements may be performed according to embodiments of the present disclosure. Telecommunications network 100 includes network nodes 101a and 101b and endpoints 102a and 102b. For example, network 100 may include a wired and/or wireless broadband network (that is, a network that may be entirely wired, entirely wireless, or some combination of wired and wireless), a 3^{rd} Generation (3G) wireless network, a 4^{th} Generation (4G) wireless network, a 3^{rd} Generation Partnership Project (3GPP) Long Term Evolution (LTE) wireless network, a wired and/or wireless Voice-over-Internet Protocol (VoIP) network, a wired and/or wireless IP Multimedia Subsystem (IMS) network, etc. Although only two nodes 101a and 101b and two endpoints 102a and 102b are shown in FIG. 1, it will be understood that network 100 may comprise any number of nodes and endpoints. Moreover, it will be understood that the nodes and endpoints in network 100 may be interconnected in any suitable manner, including being coupled to one or more other nodes and/or endpoints.

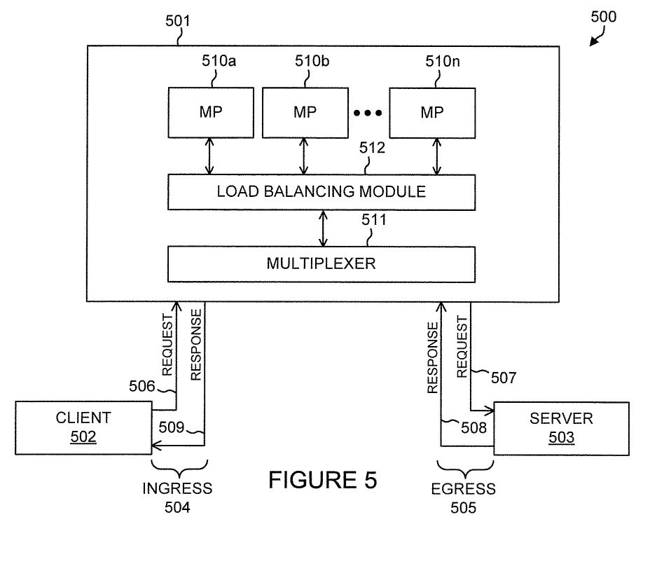

In some implementations, endpoints 102a and 102b may represent, for example, computers, mobile devices, user equipment (UE), client applications, server applications, or the like. Meanwhile, nodes 101a and 101b may be components in an intranet, Internet, or public data network, such as a router, gateway, base station or access point. Nodes 101a and 101b may also be components in a 3G or 4G wireless network, such as: a Serving GPRS Support Node (SGSN), Gateway GPRS Support Node (GGSN) or Border Gateway in a General Packet Radio Service (GPRS) network; a Packet Data Serving Node (PDSN) in a CDMA2000 network; a Mobile Management Entity (MME) in a Long Term Evolution/Service Architecture Evolution (LTE/SAE) network; or any other core network node or router that transfers data packets or messages between endpoints 102a and 102b. Examples of these, and other elements, are discussed in more detail below with respect to FIG. 4.

Still referring to FIG. 1, many packets traverse links 104 and nodes 101a and 101b as data is exchanged between endpoints 102a and 102b. These packets may represent many different sessions and protocols. For example, if endpoint 102a is used for a voice or video call, then that endpoint 102a may exchange VoIP or Session Initiation Protocol (SIP) data packets with a SIP/VoIP server (i.e., the other endpoint 102b) using Real-time Transport Protocol (RTP). Alternatively, if endpoint 102a is used to send or retrieve email, the device forming endpoint 102a may exchange Internet Message Access Protocol (IMAP), Post Office Protocol 3 (POP3), or Simple Mail Transfer Protocol (SMTP) messages with an email server (i.e., the other endpoint 102b). In another alternative, if endpoint 102a is used to download or stream video, the device forming endpoint 102a may use Real Time Streaming Protocol (RTSP) or Real Time Messaging Protocol (RTMP) to establish and control media sessions with an audio, video or data server (i.e., the other endpoint 102b). In yet another alternative, the user at endpoint 102a may access a number of websites using Hypertext Transfer Protocol (HTTP) to exchange data packets with a web server (i.e., the other endpoint 102b). In some cases, communications may be had using the GPRS Tunneling Protocol (GTP). It will be understood that packets exchanged between the devices or systems forming endpoints 102a and 102b may conform to numerous other protocols now known or later developed.

Network monitoring system 103 may be used to monitor the performance of network 100. Particularly, monitoring system 103 captures duplicates of packets that are transported across links 104 or similar interfaces between nodes 101a-101b, endpoints 102a-102b, and/or any other network links or connections (not shown). In some embodiments, packet capture devices may be non-intrusively coupled to network links 104 to capture substantially all of the packets transmitted across the links. Although only three links 104 are shown in FIG. 1, it will be understood that in an actual network there may be dozens or hundreds of physical, logical or virtual connections and links between network nodes. In some cases, network monitoring system 103 may be coupled to all or a high percentage of these links. In other embodiments, monitoring system 103 may be coupled only to a portion of network 100, such as only to links associated with a particular carrier or service provider. The packet capture devices may be part of network monitoring system 103, such as a line interface card, or may be separate components that are remotely coupled to network monitoring system 103 from different locations. Alternatively, packet capture functionality for network monitoring system 103 may be implemented as software processing modules executing within the processing systems of nodes 101a and 101b.

Monitoring system 103 may include one or more processors running one or more software applications that collect, correlate and/or analyze media and signaling data packets from network 100. Monitoring system 103 may incorporate protocol analyzer, session analyzer, and/or traffic analyzer functionality that provides OSI (Open Systems Interconnection) Layer 2 to Layer 7 troubleshooting by characterizing IP traffic by links, nodes, applications and servers on network 100. In some embodiments, these operations may be provided, for example, by the IRIS toolset available from TEKTRONIX, INC., although other suitable tools may exist or be later developed. The packet capture devices coupling network monitoring system 103 to links 104 may be high-speed, high-density 10 Gigabit Ethernet (10 GE) probes that are optimized to handle high bandwidth IP traffic, such as the GEOPROBE G10 product, also available from TEKTRONIX, INC., although other suitable tools may exist or be later developed. A service provider or network operator may access data from monitoring system 103 via user interface station 105 having a display or graphical user interface 106, such as the IRISVIEW configurable software framework that provides a single, integrated platform for several applications, including feeds to customer experience management systems and operation support system (OSS) and business support system (BSS) applications, which is also available from TEKTRONIX, INC., although other suitable tools may exist or be later developed.

Monitoring system 103 may further comprise internal or external memory 107 for storing captured data packets, user session data, and configuration information. Monitoring system 103 may capture and correlate the packets associated with specific data sessions on links 104. In some embodiments, related packets can be correlated and combined into a record for a particular flow, session or call on network 100. These data packets or messages may be captured in capture files. A call trace application may be used to categorize messages into calls and to create Call Detail Records (CDRs). These calls may belong to scenarios that are based on or defined by the underlying network. In an illustrative, non-limiting example, related packets can be correlated using a 5-tuple association mechanism. Such a 5-tuple association process may use an IP correlation key that includes 5 parts: server IP address, client IP address, source port, destination port, and Layer 4 Protocol (Transmission Control Protocol (TCP), User Datagram Protocol (UDP) or Stream Control Transmission Protocol (SCTP)).

Accordingly, network monitoring system 103 may be configured to sample (e.g., unobtrusively through duplicates) related data packets for a communication session in order to track the same set of user experience information for each session and each client without regard to the protocol (e.g., HTTP, RTMP, RTP, etc.) used to support the session. For example, monitoring system 103 may be capable of identifying certain information about each user's experience, as described in more detail below. A service provider may use this information, for instance, to adjust network services available to endpoints 102a-102b, such as the bandwidth assigned to each user, and the routing of data packets through network 100.

As the capability of network 100 increases toward 10 GE and beyond (e.g., 100 GE), each link 104 may support more user flows and sessions. Thus, in some embodiments, link 104 may be a 10 GE or a collection of 10 GE links (e.g., one or more 100 GE links) supporting thousands or tens of thousands of users or subscribers. Many of the subscribers may have multiple active sessions, which may result in an astronomical number of active flows on link 104 at any time, where each flow includes many packets.

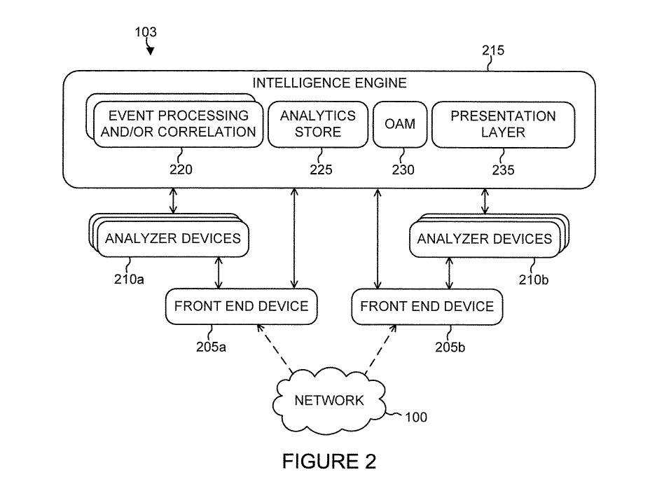

FIG. 2 is a high level diagram for an example of a network monitoring system employed as part of the network monitoring environment of FIG. 1. As shown, one or more front-end monitoring devices or probes 205a and 205b, which may form a first tier of a three-tiered architecture, may be coupled to network 100. Each front-end device 205a-205b may also each be coupled to one or more network analyzer devices 210a, 210b (i.e., a second tier), which in turn may be coupled to intelligence engine 215 (i.e., a third tier). Front-end devices 205a-205b may alternatively be directly coupled to intelligence engine 215, as described in more detail below. Typically, front-end devices 205a-205b may be capable of or configured to process data at rates that are higher (e.g., about 10 or 100 times) than analyzers 210a-210b. Although the system of FIG. 2 is shown as a three-tier architecture, it should be understood by a person of ordinary skill in the art in light of this disclosure that the principles and techniques discussed herein may be extended to a smaller or larger number of tiers (e.g., a single-tiered architecture, a four-tiered architecture, etc.). In addition, it will be understood that the front-end devices 205a-205b, analyzer devices 210a-210b, and intelligence engine 215 are not necessarily implemented as physical devices separate from the network 100, but may instead be implemented as software processing modules executing on programmable physical processing resources within the nodes 101a and 101b of network 100.

Generally speaking, front-end devices 205a-205b may passively tap into network 100 and monitor all or substantially of its data. For example, one or more of front-end devices 205a-205b may be coupled to one or more links 104 of network 100 shown in FIG. 1. Meanwhile, analyzer devices 210a-210b may receive and analyze a subset of the traffic that is of interest, as defined by one or more rules. Intelligence engine 215 may include a plurality of distributed components configured to perform further analysis and presentation of data to users. For example, intelligence engine may include: Event Processing and/or Correlation (EPC) circuit(s) 220; analytics store 225; Operation, Administration, and Maintenance (OAM) circuit(s) 230; and presentation layer 235. Each of those components may be implemented in part as software processing modules executing on programmable physical processing resources, either within a distinct physical intelligence engine device or within the nodes 101a and 101b of network 100.

In some embodiments, front-end devices 205a-205b may be configured to monitor all of the network traffic (e.g., 10 GE, 100 GE, etc.) through the links to which the respective front-end device 205a or 205b is connected. Front-end devices 205a-205b may also be configured to intelligently distribute traffic based on a user session level. Additionally or alternatively, front-end devices 205a-205b may distribute traffic based on a transport layer level. In some cases, each front-end device 205a-205b may analyze traffic intelligently to distinguish high-value traffic from low-value traffic based on a set of heuristics. Examples of such heuristics may include, but are not limited to, use of parameters such as IMEI (International Mobile Equipment Identifier) TAC code (Type Allocation Code) and SVN (Software Version Number) as well as a User Agent Profile (UAProf) and/or User Agent (UA), a customer list (e.g., international mobile subscriber identifiers (IMSI), phone numbers, etc.), traffic content, or any combination thereof. Therefore, in some implementations, front-end devices 205a-205b may feed higher-valued traffic to a more sophisticated one of analyzers 210a-210b and lower-valued traffic to a less sophisticated one of analyzers 210a-210b (to provide at least some rudimentary information).

Front-end devices 205a-205b may also be configured to aggregate data to enable backhauling, to generate netflows and certain Key Performance Indicator (KPI) calculations, time stamping of data, port stamping of data, filtering out unwanted data, protocol classification, and deep packet inspection (DPI) analysis. In addition, front-end devices 205a-205b may be configured to distribute data to the back-end monitoring tools (e.g., analyzer devices 210a-210b and/or intelligence engine 215) in a variety of ways, which may include flow-based or user session-based balancing. Front-end devices 205a-205b may also receive dynamic load information such as central processing unit (CPU) and memory utilization information from each of analyzer devices 210a-210b to enable intelligent distribution of data.

Analyzer devices 210a-210b may be configured to passively monitor a subset of the traffic that has been forwarded to it by the front-end device(s) 205a-205b. Analyzer devices 210a-210b may also be configured to perform stateful analysis of data, extraction of key parameters for call correlation and generation of call data records (CDRs), application-specific processing, computation of application specific KPIs, and communication with intelligence engine 215 for retrieval of KPIs (e.g., in real-time and/or historical mode). In addition, analyzer devices 210a-210b may be configured to notify front-end device(s) 205a-205b regarding its CPU and/or memory utilization so that front-end device(s) 205a-205b can utilize that information to intelligently distribute traffic.

Intelligence engine 215 may follow a distributed and scalable architecture. In some embodiments, EPC module 220 may receive events and may correlate information from front-end devices 205a-205b and analyzer devices 210a-210b, respectively. OAM module 230 may be used to configure and/or control front-end device(s) 205a and/or 205b and analyzer device(s) 210a and/or 210b, distribute software or firmware upgrades, etc. Presentation layer 235 may be configured to present event and other relevant information to the end-users. Analytics store 225 may include a storage or database for the storage of analytics data or the like.

In some implementations, analyzer devices 210a-210b and/or intelligence engine 215 may be hosted at an offsite location (i.e., at a different physical location remote from front-end devices 205a-205b). Additionally or alternatively, analyzer devices 210a-210b and/or intelligence engine 215 may be hosted in a cloud environment.

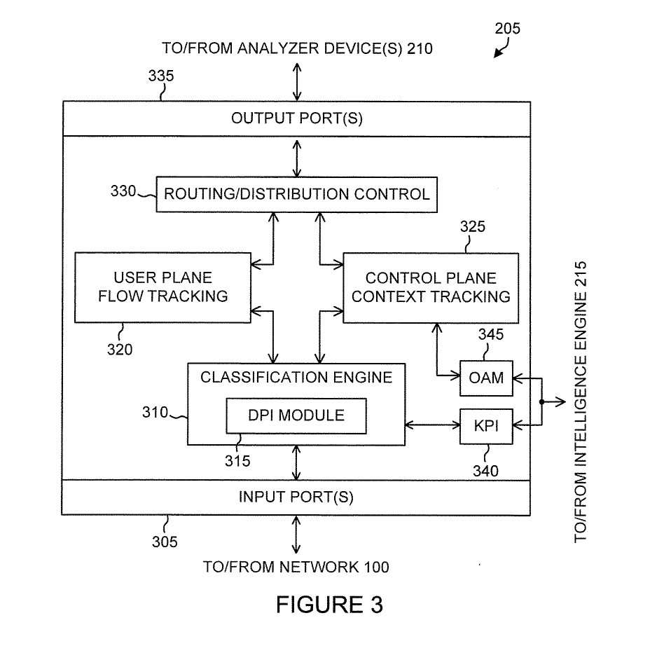

FIG. 3 is a high level diagram for an example of a network monitoring probe within the network monitoring system of FIG. 2. Input port(s) 305 for the network monitoring probe implemented by front-end device 205 (which may be either of front-end devices 205a and 205b in the example depicted in FIG. 2 or a corresponding device not shown in FIG. 2) may have throughput speeds of, for example, 8, 40, or 100 gigabits per second (Gb/s) or higher. Input port(s) 305 may be coupled to network 100 and to classification engine 310, which may include DPI module 315. Classification engine 310 may be coupled to user plane (UP) flow tracking module 320 and to control plane (CP) context tracking module 325, which in turn may be coupled to routing/distribution control engine 330. Routing engine 330 may be coupled to output port(s) 335, which in turn may be coupled to one or more analyzer devices 210. In some embodiments, KPI module 340 and OAM module 345 may also be coupled to classification engine 310 and/or tracking modules 320 and 325, as well as to intelligence engine 215.

In some implementations, each front-end probe or device 205 may be configured to receive traffic from network 100, for example, at a given data rate (e.g., 10 Gb/s, 100 Gb/s, etc.), and to transmit selected portions of that traffic to one or more analyzers 210a and/or 210b, for example, at a different data rate. Classification engine 310 may identify user sessions, types of content, transport protocols, etc. (e.g., using DPI module 315) and transfer UP packets to flow tracking module 320 and CP packets to context tracking module 325. In some cases, classification engine 310 may implement one or more rules to allow it to distinguish high-value traffic from low-value traffic and to label processed packets accordingly. Routing/distribution control engine 330 may implement one or more load balancing or distribution operations, for example, to transfer high-value traffic to a first analyzer and low-value traffic to a second analyzer. Moreover, KPI module 340 may perform basic KPI operations to obtain metrics such as, for example, bandwidth statistics (e.g., per port), physical frame/packet errors, protocol distribution, etc.

The OAM module 345 of each front-end device 205 may be coupled to OAM module 230 of intelligence engine 215 and may receive control and administration commands, such as, for example, rules that allow classification engine 310 to identify particular types of traffic. For instance, based on these rules, classification engine 310 may be configured to identify and/or parse traffic by user session parameter (e.g., IMEI, IP address, phone number, etc.). In some cases, classification engine 310 may be session context aware (e.g., web browsing, protocol specific, etc.). Further, front-end device 205 may be SCTP connection aware to ensure, for example, that all packets from a single connection are routed to the same one of analyzers 210a and 210b.

In various embodiments, the components depicted for each front-end device 205 may represent sets of software routines and/or logic functions executed on physical processing resource, optionally with associated data structures stored in physical memories, and configured to perform specified operations. Although certain operations may be shown as distinct logical blocks, in some embodiments at least some of these operations may be combined into fewer blocks. Conversely, any given one of the blocks shown in FIG. 3 may be implemented such that its operations may be divided among two or more logical blocks. Moreover, although shown with a particular configuration, in other embodiments these various modules may be rearranged in other suitable ways.

FIG. 4 is a diagram of an exemplary 3GPP SAE network for which the network monitoring system of FIGS. 1 and 2 may be deployed according to some embodiments of the present disclosure. The 3GPP network 400 depicted in FIG. 4 may form the network portion of FIG. 1 and may include the monitoring system 103 (not shown in FIG. 4). As illustrated, User Equipment (UE) 401 is coupled to one or more Evolved Node B (eNodeB or eNB) base station(s) 402 and to Packet Data Gateway (PDG) 405. Meanwhile, eNB 402 is also coupled to Mobility Management Entity (MME) 403, which is coupled to Home Subscriber Server (HSS) 404. PDG 405 and eNB 402 are each coupled to Serving Gateway (SGW) 406, which is coupled to Packet Data Network (PDN) Gateway (PGW) 407, and which in turn is coupled to Internet 408, for example, via an IMS (not shown).

Generally speaking, eNB 402 may include hardware configured to communicate with UE 401. MME 403 may serve as a control-node for the access portion of network 400, responsible for tracking and paging UE 401, coordinating retransmissions, performing bearer activation/deactivation processes, etc. MME 403 may also be responsible for authenticating a user (e.g., by interacting with HSS 404). HSS 404 may include a database that contains user-related and subscription-related information to enable mobility management, call and session establishment support, user authentication and access authorization, etc. PDG 405 may be configured to secure data transmissions when UE 401 is connected to the core portion of network 400 via an entrusted access. SGW 406 may route and forward user data packets, and PDW 407 may provide connectivity from UE 401 to external packet data networks, such as, for example, Internet 408.

In operation, one or more of elements 402-407 may perform one or more Authentication, Authorization and Accounting (AAA) operation(s), or may otherwise execute one or more AAA application(s). For example, typical AAA operations may allow one or more of elements 402-407 to intelligently control access to network resources, enforce policies, audit usage, and/or provide information necessary to bill a user for the network's services.

In particular, “authentication” provides one way of identifying a user. An AAA server (e.g., HSS 404) compares a user's authentication credentials with other user credentials stored in a database and, if the credentials match, may grant access to the network. Then, a user may gain “authorization” for performing certain tasks (e.g., to issue predetermined commands), access certain resources or services, etc., and an authorization process determines whether the user has authority do so. Finally, an “accounting” process may be configured to measure resources that a user actually consumes during a session (e.g., the amount of time or data sent/received) for billing, trend analysis, resource utilization, and/or planning purposes. These various AAA services are often provided by a dedicated AAA server and/or by HSS 404. A standard protocol may allow elements 402, 403, and/or 405-407 to interface with HSS 404, such as the Diameter protocol that provides an AAA framework for applications such as network access or IP mobility and is intended to work in both local AAA and roaming situations. Certain Internet standards that specify the message format, transport, error reporting, accounting, and security services may be used by the standard protocol.

Although FIG. 4 shows a 3GPP SAE network 400, it should be noted that network 400 is provided as an example only. As a person of ordinary skill in the art will readily recognize in light of this disclosure, at least some of the techniques described herein may be equally applicable to other types of networks including other types of technologies, such as Code Division Multiple Access (CDMA), 2^{nd} Generation CDMA (2G CDMA), Evolution-Data Optimized 3^{rd} Generation (EVDO 3G), etc.

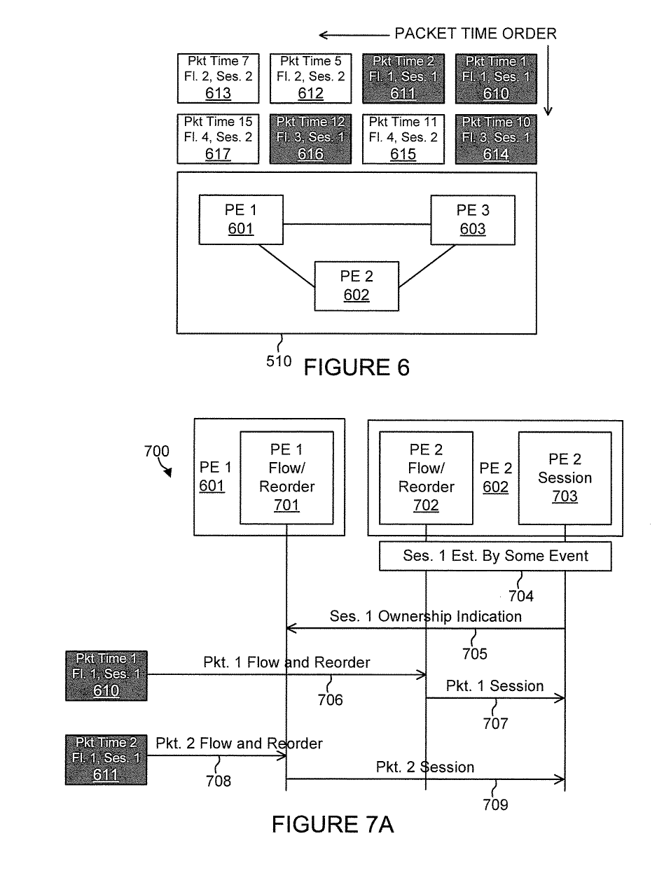

FIG. 5 is a high level diagram for an example of a portion of a network where the network monitoring system of FIGS. 1 and 2 may be deployed according to some embodiments of the present disclosure. As shown, client 502 communicates with routing device or core 501 via ingress interface or hop 504, and routing core 501 communicates with server 503 via egress interface or hop 505. Examples of client 502 include, but are not limited to, MME 403, SGW 406, and/or PGW 407 depicted in FIG. 4, whereas examples of server 503 include HSS 404 depicted in FIG. 4 and/or other suitable AAA server. Routing core 501 may include one or more routers or routing agents such as Diameter Signaling Routers (DSRs) or Diameter Routing Agents (DRAs), generically referred to as Diameter Core Agents (DCAs).

In order to execute AAA application(s) or perform AAA operation(s), client 502 may exchange one or more messages with server 503 via routing core 501 using the standard protocol. Particularly, each call may include at least four messages: first or ingress request 506, second or egress request 507, first or egress response 508, and second or ingress response 509. The header portion of these messages may be altered by routing core 501 during the communication process, thus making it challenging for a monitoring solution to correlate these various messages or otherwise determine that those messages correspond to a single call.

In some embodiments, however, the systems and methods described herein enable correlation of messages exchanged over ingress hops 504 and egress hops 505. For example, ingress and egress hops 504 and 505 of routing core 501 may be correlated by monitoring system 103, thus alleviating the otherwise costly need for correlation of downstream applications.

In some implementations, monitoring system 103 may be configured to receive (duplicates of) first request 506, second request 507, first response 508, and second response 509. Monitoring system 103 may correlate first request 506 with second response 509 into a first transaction and may also correlate second request 507 with first response 508 into a second transaction. Both transactions may then be correlated as a single call and provided in an External Data Representation (XDR) or the like. This process may allow downstream applications to construct an end-to-end view of the call and provide KPIs between LTE endpoints.

Also, in some implementations, Intelligent Delta Monitoring may be employed, which may involve processing ingress packets fully but then only a “delta” in the egress packets. Particularly, the routing core 501 may only modify a few specific Attribute-Value Pairs (AVPs) of the ingress packet's header, such as IP Header, Origin-Host, Origin-Realm, and Destination-Host. Routing core 501 may also add a Route-Record AVP to egress request messages. Accordingly, in some cases, only the modified AVPs may be extracted without performing full decoding transaction and session tracking of egress packets. Consequently, a monitoring probe with a capacity of 200,000 Packets Per Second (PPS) may obtain an increase in processing capacity to 300,000 PPS or more—that is, a 50% performance improvement—by only delta processing egress packets. Such an improvement is important when one considers that a typical implementation may have several probes monitoring a single DCA, and several DCAs may be in the same routing core 501. For ease of explanation, routing core 501 of FIG. 5 is assumed to include a single DCA, although it should be noted that other implementations may include a plurality of DCAs.

Additionally or alternatively, the load distribution within routing core 501 may be measured and managed. Each routing core 501 may include a plurality of message processing (MP) blades and/or interface cards 510a, 510b, . . . , 510n, each of which may be associated with its own unique origin host AVP. In some cases, using the origin host AVP in the egress request message as a key may enable measurement of the load distribution within routing core 501 and may help in troubleshooting. As illustrated, multiplexer module 511 within routing core 501 may be configured to receive and transmit traffic from and to client 502 and server 503. Load balancing module 512 may receive traffic from multiplexer 511, and may allocate that traffic across various MP blades 510a-510n and even to specific processing elements on a given MP blade in order to optimize or improve operation of core 501.

For example, each of MP blades 510a-510n may perform one or more operations upon packets received via multiplexer 511, and may then send the packets to a particular destination, also via multiplexer 511. In that process, each of MP blades 510a-510n may alter one or more AVPs contained in these packets, as well add new AVPs to the packets (typically to the header). Different fields in the header of request and response messages 506-509 may enable network monitoring system 103 to correlate the corresponding transactions and calls while reducing or minimizing the number of operations required to performs such correlations.

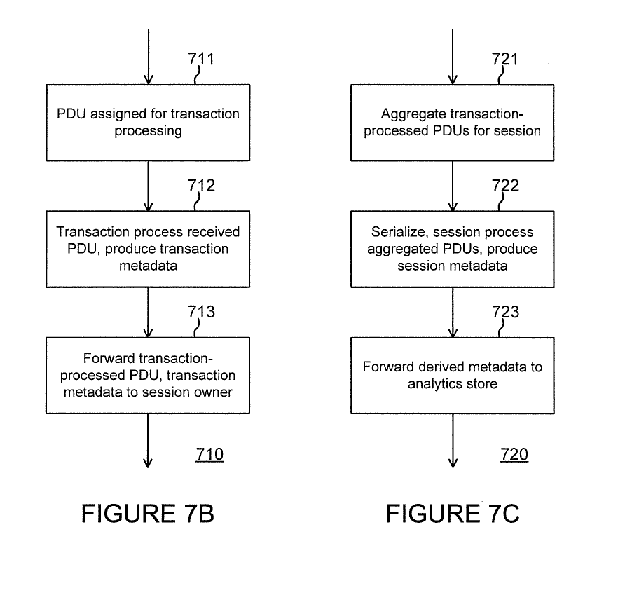

FIG. 6 is a diagram illustrating a monitoring model employed for distributed processing and ordering of monitored packets with tightly-coupled processing elements within the network monitoring system of FIGS. 1 and 2 according to embodiments of the present disclosure. In general, a packet-based network is monitored using a device with tightly-coupled processing elements. Processing power is realized by evenly distributing work across those elements. However, this distribution may be at cross-purposes to monitoring network protocols, which are inherently ordered. In order to process the work as atomic units and, at the same time, respect any protocol exchange to which those units belong, a technique is employed for unambiguously ordering and processing the work when load-balancing is not time-ordered.

The monitoring model employed includes a plurality of tightly-coupled processing elements 601, 602 and 603 on, for example, an MP blade 510 within the MP blades 510a-510n depicted in FIG. 5. Each processing element 601, 602 and 603 includes hardware processing circuitry and associated memory or other data storage resources configured by programming to perform specific types of processing, as described in further detail below. Processing elements 601, 602 and 603 are “tightly-coupled” by being coupled with each other by a high throughput or high speed data channel that supports data rates of at least 40 Gbs. Processing elements 601, 602 and 603 may also be mounted on a single printed circuit board (PCB) or blade 510, or alternatively may be distributed across different PCBs or blades 510a-510n connected by a high speed data channel. Of course, more than three processing elements may be utilized in a particular implementation of the monitoring model illustrated by FIG. 6.

The protocol data units (PDUs) 610-617 shown in FIG. 6, which are packets in the example described herein, relate to two sessions: session 1, for which PDUs are depicted in dark shaded boxes, and session 2, for which PDUs are depicted in light background boxes. Each session comprises at least one “flow,” a request-response message pair forming a transaction between and endpoint and node or between nodes. For instance, a flow may comprise the request 506 and associated response 509 or the request 507 and associated response 508 depicted in FIG. 5. In the example shown in FIG. 6, eight PDUs relating to four flows within the two sessions are depicted. Each PDU is marked with a time-ordering sequence reference such as the time-stamp described above or an incremental PDU or packet sequence number. In the example of FIG. 6, PDU 610 is marked based on packet time 1 and relates to flow 1 of session 1, while PDU 611 is marked based on packet time 2 but also relates to flow 1 of session 1. PDUs 612 and 613 are marked based on packet times 5 and 7, respectively, and both relate to flow 2 forming part of session 2. PDUs 614 and 616 are marked based on packet times 10 and 12, respectively, and both relate to flow 3 within session 1, while PDUs 615 and 617 are respectively marked based on packet times 11 and 15 and both relate to flow 4, within session 2.

A goal in monitoring a network is to create meaningful metadata that describes the state of the network. As noted, the PDUs belong to flows, where each flow is a brief exchange of signaling (e.g., request-response), and a set of flows rolls up into a session. Processing elements 601-603 in the network monitoring system 103 each manage a set of sessions, where a session is a set of flows between a pair of monitored network elements (e.g., endpoints 102a-102b in FIG. 1, UE 401 and eNB 402 in FIG. 4, or client 502 and server 503 in FIG. 5). Each processing element 601, 602 and 603 publishes (or “advertises”) to the remaining processing elements that it owns a particular set of sessions.

The model described above assumes that PDUs, while not necessarily balanced by time order, are marked according to time order. The PDUs may then be scattered across processing elements 601, 602, and 603 by some means—say, randomly or by a well-distributed protocol sequence number. Additionally, processing of the PDUs is staged so that metadata is created for both the PDUs themselves and for the endpoints, at a protocol flow, transaction, and session level. Transaction or flow metadata may include, for example, the number of bytes in the messages forming a transaction. Session metadata may include, for example, a number of transactions forming a session or a type of data (audio, video, HTML, etc.) exchanged in the session.

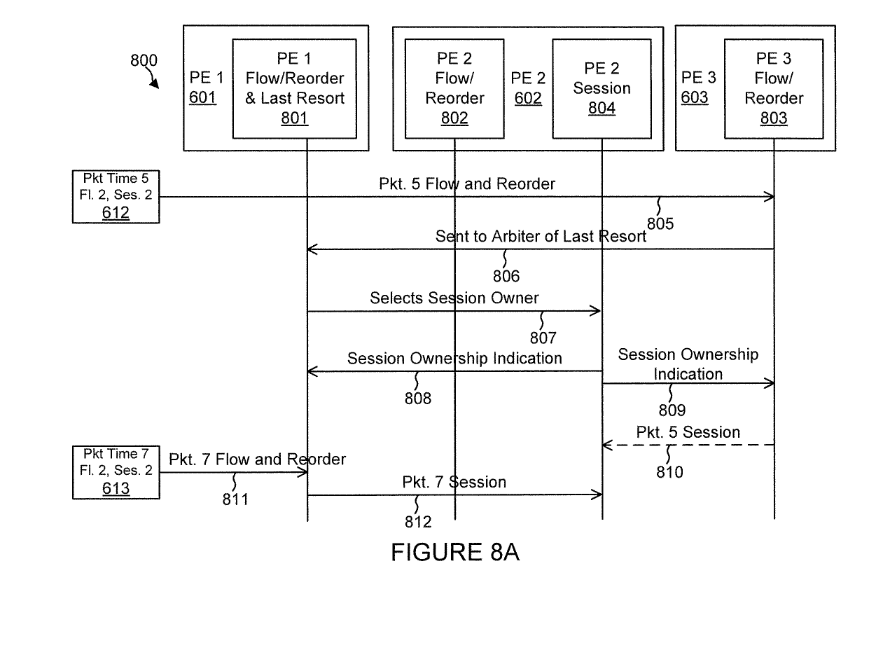

FIG. 7A is a timing diagram illustrating operation of the network monitoring system of FIGS. 1 and 2 during distributed processing and ordering of monitored packets with established session ownership using tightly-coupled processing elements according to embodiments of the present disclosure. The monitoring model of FIG. 6 is employed for distributed processing and ordering of monitored packets. The distributed processing and reordering described in connection with FIG. 7A is performed by a group of processing elements 601-603 forming the processing resources within analyzer devices 210a, 210b, the processing resources of intelligence engine 215, or some combination of the two. The distributed processing and reordering described is performed by the processing elements 601-603 with the benefit of information determined by the flow tracking module 302 and context tracking module 325 within one or more of front-end device(s) 205a, 205b. For simplicity and clarity, only two of the processing elements depicted in FIG. 6, PE 1 601 and PE2 602, are depicted in the operational example of FIG. 7A.

The flow or transaction processing and reorder functionality 701, 702 for PE 1 601 and PE 2 602, respectively, in FIG. 6 are separately depicted in FIG. 7A, as is the session processing functionality 703 for PE 2 602. As illustrated, a session (session 1 in the example shown) is established by some event 704, such as a user placing a voice call or initiating play of a video from a website. Ownership of that session is assigned to PE 2 602, with the session processing functionality 703 for PE 2 602 publishing or advertising an ownership indication 705 to remaining processing elements among which the work is distributed, including processing element PE 3 603 and any other processing element.

Within the process of ordering PDUs at a processing element 601-603, flow or transaction work or processing on a particular PDU may occur at a processing element PE 2 602 that also monitors the session to which PDU belongs. Thus, for example, packet 1 610 may be directed (by load balancing module 512, for example) by message 706 or similar work assignment indication to PE 2 flow processing and reorder functionality 702 for transaction (flow) processing of PDU 610. In such a case, the work for transaction processing PDU 610 is inserted into a priority queue for transaction processing and reorder functionality 702 by time order. Because accommodation is made for work that may be under transaction or flow processing on a related PDU belonging to the same session at some remote processing element, the work spends some time in the queue before being removed. This allows the remote work time to arrive and be ordered correctly. Accordingly, the time spent in the queue should be greater than the expected latency for work to be distributed across the monitoring network system's processing elements and the latency for the PDU itself to be flow-processed. Once transaction processing on PDU 610 is complete, the transaction-processed PDU and associated transaction metadata are forwarded by message 707 or similar work transfer mechanism to PE 2 session processing functionality 703.

Flow work at a processing element that does not own the flow's session occurs normally. In the example of FIG. 7A, packet 2 611 may be directed by work assignment message 708 to PE 1 flow processing and reorder functionality 701 for transaction processing. The work is then forwarded to the session owner, which has possibly advertised ownership. In that case, the transaction-processed PDU and associated transaction metadata are forwarded by work transfer message 709 from PE 1 transaction processing and reorder functionality 701 to PE 2 session processing functionality 703. For sessions that the network monitor has yet to discover, a single ordering-authority of last resort is employed to control serialization of the owner-less session work, as discussed in further detail below.

FIG. 7B is a portion of a flowchart illustrating transaction processing in accordance with the process illustrated in FIG. 7A. The process 710 depicted is performed using the transaction processing and reorder functionality 701 or 702 of either processing element 601 or 602, or the corresponding functionality for processing element 603 or another processing element. The process includes a PDU being assigned to and received by the processing element for transaction processing (step 711). The processing element transaction-processes the received PDU to produce transaction metadata (step 712). As described above, some latency may be associated with the transaction processing to allow time for transaction processing of other PDUs for the session to be processed by other processing elements. Because session ownership for the session to which the PDU relates was previously advertised, the processing element can readily determine the session owner and forwards the transaction-processed PDU and associated transaction metadata to the session owner (step 713). This process 710 is repeated for each PDU assigned to the processing element for transaction processing.

FIG. 7C is a portion of a flowchart illustrating session processing in accordance with the process illustrated in FIG. 7A. The process 720 depicted is performed using the session processing functionality 704 of the session owning processing element 602, or the corresponding functionality for one of processing elements 601 or 603 or another processing element when the respective processing element is the session owner. The process includes receiving, aggregating, and serializing (re-ordering or restoring the order of the PDUs as initially received based on the time-ordering sequence references within the PDUs) the received transaction-processed PDUs for a session owned by the respective processing element 602 (step 721). In some embodiments, the processing element 602 may be configured to check for missing PDUs based on gaps in the time-ordering sequence references. The session-owning processing element 602 session-processes the aggregated PDUs to produce session metadata (step 722), which generally requires context information not always available to the processing element that performed transaction processing on one or more of the aggregated PDUs. The session-owning processing element 602 then forwards the derived metadata to at least the analytics store 225 of intelligence engine 215 (step 723). The derived metadata forwarded to the analytics store 225 may include a portion of the transaction metadata and the session metadata, or both the transaction metadata and the session metadata in their entirety. In implementations where the transaction-processing and session-processing is performed within analyzer devices 210a, 210b, the derived metadata may be forwarded to intelligence engine 215. This process 720 is repeated for each session assigned to the session-owning processing element 602.

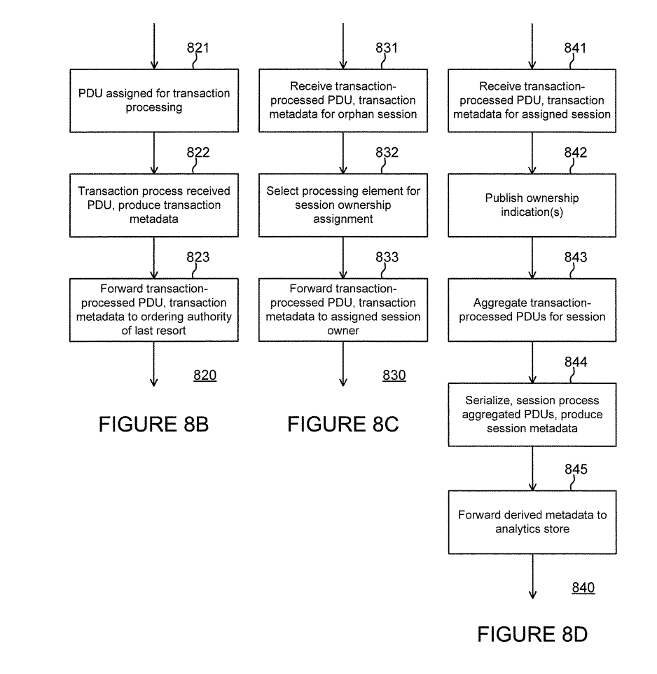

FIG. 8A is a timing diagram and FIGS. 8B, 8C and 8D are portions of flowcharts illustrating operation of the network monitoring system of FIGS. 1 and 2 during distributed processing and ordering of monitored packets with unknown session ownership using tightly-coupled processing elements according to embodiments of the present disclosure. The monitoring model of FIG. 6 is employed for distributed processing and ordering of monitored packets, with one of the processing elements (processing element PE 1 601 in the example being described) designated as the arbiter or ordering authority of last resort. The ordering authority of last resort performs ordering and serialization for “orphan” flow-processed work whose session membership is unknown, as may happen, for example, with the first transaction of a new session. A priority queue analogous to the reordering queues at each processing element processes this work. As the processed work expires from the queue, the work is assigned a session-owning processing element and forwarded appropriately.

As with FIG. 7A, the distributed processing and reordering described in connection with FIG. 8A is performed by a group of processing elements 601-603 forming the processing resources within analyzer devices 210a, 210b, the processing resources of intelligence engine 215, or some combination of the two. The distributed processing and reordering described is performed by the processing elements 601-603 with the benefit of information determined by the flow tracking module 302 and context tracking module 325 within one or more of front-end device(s) 205a, 205b. For clarity, flow or transaction processing and reorder functionality 802 for PE 2 602 is separately depicted from session processing functionality 804 for PE 2 602 in FIG. 8A, and the transaction processing, reorder and ordering authority of last resort functionality 801 for PE 1 601 and the transaction processing and reorder functionality 803 for PE 3 603 are also distinctly depicted.

As illustrated in FIG. 8A, an “orphan” PDU—that is, a PDU for a session of unknown ownership, packet 5 612 for session 2 in the example shown—is directed by load balancing module 512 or other functionality to PE 3 flow processing and reorder functionality 803 for transaction (flow) processing of PDU 612, using work assignment message 805. The work for transaction processing PDU 612 is inserted into a priority queue within transaction processing and reorder functionality 803 by time order. Once transaction processing on PDU 612 is complete, the transaction-processed PDU and associated transaction metadata are forwarded by work transfer message 806 to the ordering authority of last resort functionality 801 of processing element PE 1 601. In an alternative embodiment, only a request for assignment of the orphan session is transmitted from PE 3 transaction processing and reorder functionality 803 to ordering authority of last resort functionality 801, not the transaction-processed PDU 612 and associated transaction metadata.

The ordering authority of last resort functionality 801 will assign session ownership for the orphan PDU/session to one of the processing elements 601, 602 or 603. The transaction-processed PDU and associated transaction metadata are forwarded by a work transfer message 807 to session processing functionality of the processing element assigned ownership of the session, which is session processing functionality 804 of processing element PE 2 602 in the example shown. In the alternative embodiment mentioned above, the message 807 is only an indication of assignment of session ownership to the processing element PE 2 602, and does not include the transaction-processed PDU and associated transaction metadata. The selection of one of processing elements 601, 602 and 603 by the ordering authority of last resort functionality 801 for assignment of ownership of an orphan session may be in any of a variety of manners: by round-robin selection, by random assignment, by taking into account load balancing considerations, etc. In the alternative embodiment described above, in which the transaction-processed PDU and associated transaction metadata were not forwarded with ownership request message 806 from transaction processing and reorder functionality 803 to the ordering authority of last resort functionality 801, ownership of the session may simply be assigned to the processing element PE 3 603 that performed the transaction-processing of the PDU. Assignment to the processing element requesting indication of session ownership may be conditioned on whether other PDUs for that session have been received and transaction-processed by other processing elements, or on the current loading at the requesting processing element (processing element PE 3 603 in the example described)

Upon receiving the work transfer message 807, the session processing functionality 804 of processing element PE 2 602, having been assigned ownership of the session, publishes or advertises one or more ownership indication(s) 808, 809 to the remaining processing elements PE1 601 and PE 3 603 among which the work is distributed. In the alternative embodiment described above, in which the transaction-processed PDU and associated transaction metadata were not forwarded with ownership request message 806 from transaction processing and reorder functionality 803 to the ordering authority of last resort functionality 801, the transaction processing and reorder functionality 803 may forward transaction-processed PDU and associated transaction metadata to the now-published session owner, processing element PE 2 602.

As with FIG. 7A, in the example of FIG. 8A flow work at a processing element that does not own the flow's session occurs normally. When packet 7 613 is directed by work assignment message 811 to PE 1 flow processing and reorder functionality 801 for transaction processing subsequent to the session ownership indication(s) 808, 809, the PDU is transaction processed by flow processing and reorder functionality 801. The transaction-processed work and associated transaction metadata are then forwarded to the session owner by work transfer message 812 from PE 1 transaction processing and reorder functionality 801 to PE 2 session processing functionality 804.

FIG. 8B is a portion of a flowchart illustrating session ownership allocation in accordance with the process illustrated in FIG. 8A. The process 820 depicted is performed using the transaction processing and reorder functionality 801, 802 or 803 of any of processing elements 601, 602 or 603, or the corresponding functionality of another processing element. The process includes a PDU for an orphan session being assigned to and received by the processing element for transaction processing (step 821). The processing element transaction-processes the received PDU to produce transaction metadata (step 822). The processing element then forwards the transaction-processed PDU and associated transaction metadata to the ordering authority of last resort (step 823). This process 820 is repeated for each PDU for an orphan session that is assigned to the processing element for transaction processing.

FIG. 8C is a portion of a flowchart illustrating session ownership allocation in accordance with the process illustrated in FIG. 8A. The process 830 depicted is performed using the transaction processing and reorder functionality 801, 802 or 803 of any of processing elements 601, 602 or 603, or the corresponding functionality of another processing element. The process includes a transaction-processed PDU and associated transaction metadata for an orphan session being received by the ordering authority of last resort processing element in the distributed processing system (step 831). The ordering authority of last resort element selects one of the processing elements within the distributed processing system for assignment of ownership over the orphan session (step 832), which may include any of itself, the processing element that performed transaction processing on the PDU, and any other processing element having session processing capability. The ordering authority of last resort processing element forwards the transaction-processed PDU and associated transaction metadata to the assigned session owner (step 833). This process 830 is repeated for each PDU for an orphan session that is received by the ordering authority of last resort processing element.

FIG. 8D is a portion of a flowchart illustrating session processing in accordance with the process illustrated in FIG. 8A. The process 840 depicted is performed with the session processing functionality 704 of the processing element 602 that was assigned ownership of the previously-unassigned session by the ordering authority of last resort, or the corresponding functionality for one of processing elements 601 or 603 or another processing element when the respective processing element is the new session owner. The process includes receiving a transaction-processed PDU and associated transaction metadata for the session now assigned to the processing element 602 and the session processing functionality 804 for processing element 602 (step 841). The session processing functionality 804 publishes one or more indications of ownership over the session to remaining processing elements 601, 603 (step 842). Those skilled in the art will note that a session ownership indication need not necessarily be published to the ordering authority of last resort processing element 601, which assigned ownership of the session to processing element 602. The process then includes receiving, aggregating the transaction-processed PDUs for the session (step 843), and then serializing and session processing the aggregated, serialized PDUs to produce session metadata (step 844). The session-owning processing element 602 then forwards (all or part of) the derived metadata to at least the analytics store 225 of intelligence engine 215 (step 845). This process 840 is repeated for each orphan session assigned to the session-owning processing element 602.

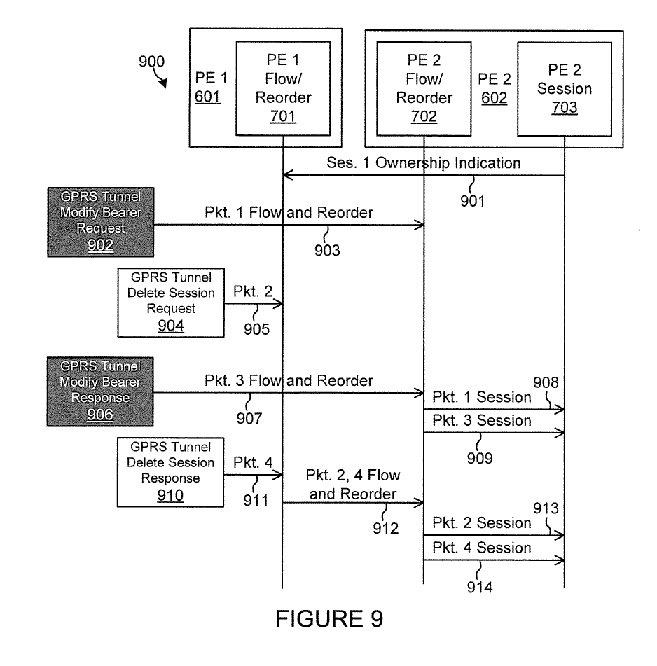

FIG. 9 is a counterpart timing diagram to FIG. 7A in a network employing the GPRS tunneling protocol. In the timing 900 illustrated, the session processing functionality 703 for PE 2 602 advertises an ownership indication 901 for an established session (session 1) to remaining processing elements within the distributed processing system. A GPRS tunnel modify bearer request (packet 1) 902 is assigned for transaction processing by message 903 to the transaction processing and reorder functionality 702 for processing element PE 2 602. A subsequent GPRS tunnel delete session request (packet 2) 904 relating to the same session is directed by message 905 to the transaction processing and reorder functionality 701 for processing element PE 1 601, while the GPRS tunnel modify bearer response (packet 3) 906 for the session is directed by message 907 to the transaction processing and reorder functionality 702 for processing element PE 2 602. When transaction processing and reorder functionality 702 completes transaction processing of packets 1 and 3, the transaction-processed packets and associated transaction metadata are forwarded by messages 908 and 909, respectively, to session processing functionality 703 for processing element PE2 602. A GPRS tunnel delete session response (packet 4) 910 relating to the session is directed by message 911 to the transaction processing and reorder functionality 701 for processing element PE 1 601. Transaction processing and reorder functionality 701 transaction-processes packets 2 and 4 and then forwards those packets in message 912 for possible additional transaction processing to transaction processing and reorder functionality 702 for session-owning processing element PE2 602. When transaction processing and reorder functionality 702 completes transaction processing of packets 2 and 4, the transaction-processed packets and associated transaction metadata are forwarded by messages 913 and 914, respectively, to session processing functionality 703 for processing element PE2 602. In monitoring a GPRS Tunnel Protocol (GTP) Control network, two GTP transactions, packets {1, 3} and packets {2, 4}, may arrive close together. Session processing occurs at processing element PE 2. As the messages are flow-processed where they arrive, they are forwarded from either processing element PE 1 601 or PE 2 602 to processing element PE 2 session processing functionality 703. This demonstrates how work can be distributed across multiple processing elements.

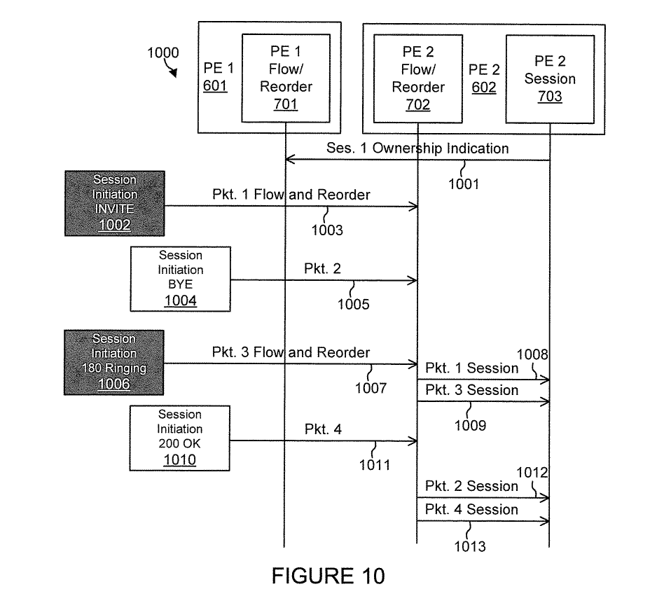

FIG. 10 is a counterpart timing diagram to FIG. 7A in a network employing the Session Initiation Protocol. In the timing 1000 illustrated, the session processing functionality 703 for PE 2 602 advertises an ownership indication 1001 for an established session (session 1) to remaining processing elements within the distributed processing system. A Session Initiation INVITE packet (packet 1) 1002 is assigned for transaction processing by message 1003 to the transaction processing and reorder functionality 702 for processing element PE 2 602. A subsequent Session Initiation BYE packet (packet 2) 1004 relating to the same session is directed by message 1005 to the transaction processing and reorder functionality 702 for processing element PE 2 602, as is a Session Initiation 180 Ringing packet (packet 3) 1006 for the session. When transaction processing and reorder functionality 702 completes transaction processing of packets 1 and 3, the transaction-processed packets and associated transaction metadata are forwarded by messages 1008 and 1009, respectively, to session processing functionality 703 for processing element PE2 602. A Session Initiation 200 OK packet (packet 4) 1010 relating to the session is directed by message 1011 to the transaction processing and reorder functionality 702 for processing element PE 2 602. When transaction processing and reorder functionality 702 completes transaction processing of packets 2 and 4, the transaction-processed packets and associated transaction metadata are forwarded by messages 1012 and 1013, respectively, to session processing functionality 703 for processing element PE 2 602. This solution may be used to monitor the SIP when two SIP transactions, packets {1, 3} and packets {2, 4}, arrive close together. In this example flow and session processing all occurs at processing element PE 2. As the messages are flow-processed where they arrive, they are reordered and delivered to processing element PE 2 session processing functionality 703.

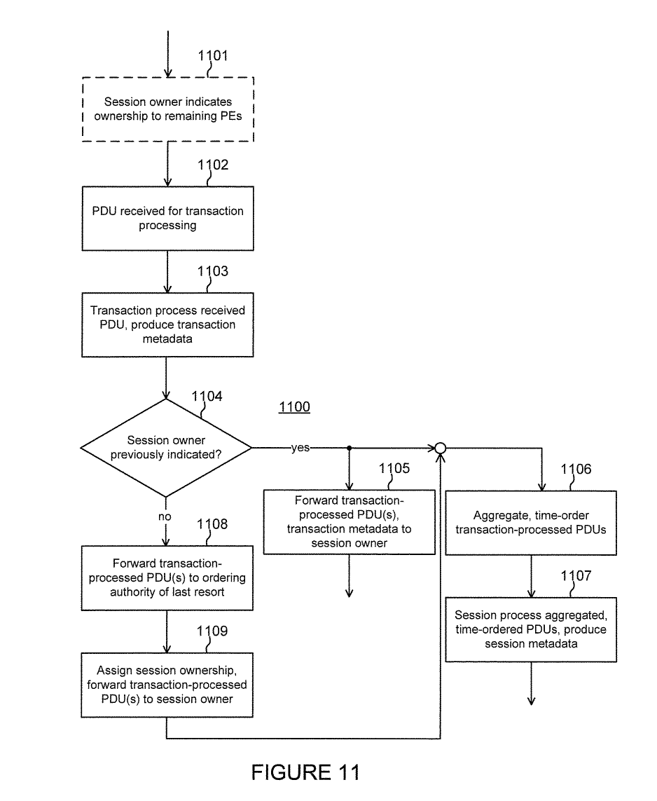

FIG. 11 is a portion of a flowchart illustrating operation of the network monitoring system of FIGS. 1 and 2 during distributed transaction-processing and session-processing of monitored packets using tightly-coupled processing elements according to embodiments of the present disclosure. The process 1100 depicted is performed using at least one and as many as all three of processing elements 601, 602 or 603. The process 1100 may include a session owner processing element 601 for a session on the monitored network indicating ownership of the session to remaining processing elements 602 and 603 (step 1101). Alternatively, the session ownership indication may not have been sent by the time of the start of the process 1100.

The process 1100 includes receiving one or more PDUs relating to a session on a monitored network at one or more of the processing elements 601, 602 and 603 (step 1102). In practice, some PDUs for the session may be received by each of the processing elements 601, 602 and 603, although in some cases only two of the processing elements 602 and 603 might receive PDUs for the session. Different ones of the processing elements 601, 602 and 603 may receive different numbers or proportions of the PDUs for the session based on, for instance, load balancing or other considerations. Each PDU for the session that is received by one of the processing elements 601, 602 and 603 is marked with a time-ordering sequence reference. Such marking may be performed, for example, by front-end devices 205a-205b. Each processing element 601, 602 and 603 receiving at least one PDU for the session performs transaction processing on the received PDUs to generate transaction metadata based upon the received PDUs (step 1103).

Depending on whether the session owner for the session was previously indicated to processing elements within the distributed processing system (step 1104), processing elements 602 and 603 may forward transaction-processed PDUs and associated transaction metadata to the session owner processing element 601 (step 1105), with the session-owning processing element 601 concurrently aggregating and time-ordering the transaction-processed PDUs relating to the session (step 1106). Where the session-owning processing element 601 transaction-processed one or more PDUs relating to the session, the transaction-processed PDUs and transaction metadata are simply forwarded from the transaction processing and reorder functionality of the processing element 601 to the session processing functionality of the processing element 601. Moreover, the session-owning processing element 601 aggregates and time-orders the transaction-processed PDUs relating to the session even if the processing element 601 received no PDUs from the session for transaction processing. The session owner processing element 601 session processes the aggregated, time-ordered, transaction-processed PDUs to generate session metadata (step 1107).

When none of the processing elements 601, 602, or 603 has previously indicated ownership of the session (i.e., step 1101 did not occur at the start of the process 1100), the transaction processed PDUs are forwarded to a processing element 601 designated as the ordering authority of last resort (step 1108), which assigns ownership of the session to one of the processing elements 601, 602 or 603 and forwards the received transaction-processed PDUs and associated transaction metadata to the new owner for the session (step 1109). The session owner then proceeds with aggregating, time-ordering, and session processing the transaction-processed PDUs to produce session metadata.

The present disclosure provides a novel architecture for network monitoring devices. Previous solutions required a single processing element to produce metadata for all messages/flows within a session. The processing work may now be distributed across multiple processing elements. Additionally, the solutions of the present disclosure may be easily abstracted to a virtual environment, since processing elements are readily implemented as virtual network entities. Such abstraction would allow the solutions to scale up or down with available resources. The solutions of the present disclosure enable performance of a monitoring function using a cluster of processors, with the load on a set of processors scaling linearly with the volume of monitored data to produces both flow and session metadata.

The solutions of the present disclosure allow monitoring of protocols that are not readily load-balanced with respect to time using a tightly-coupled multiprocessor system. This satisfies the need to evenly utilize processing elements, allows higher monitoring capacity, and accurately creates metadata regarding the state of monitored data. Value is created by allowing a greater hardware density that will monitor large volumes of data, providing for an economy of scale.

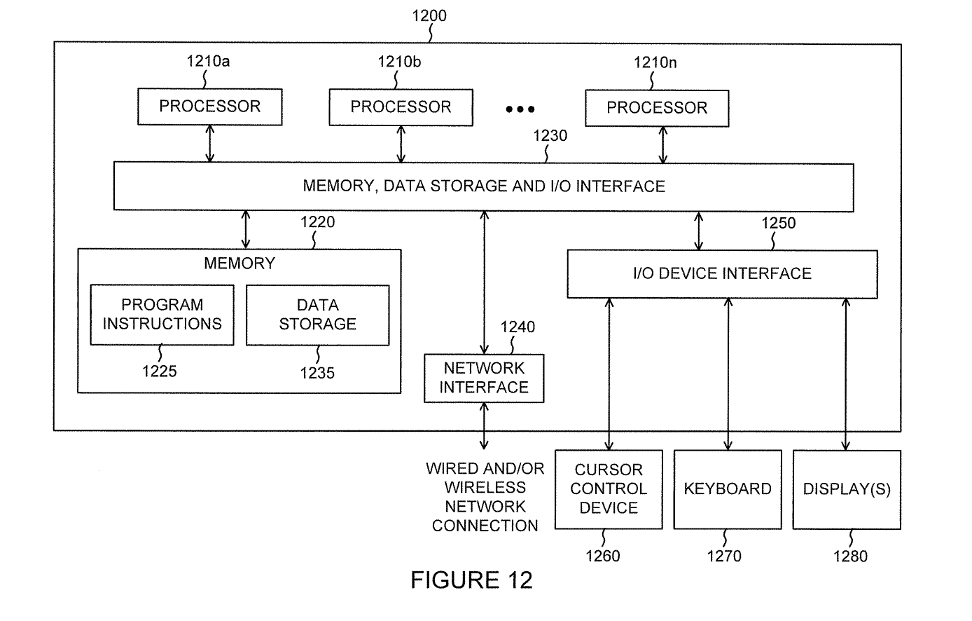

Aspects of network monitoring system 103 and other systems depicted in the preceding figures may be implemented or executed by one or more computer systems. One such computer system is illustrated in FIG. 12. In various embodiments, computer system 1200 may be a server, a mainframe computer system, a workstation, a network computer, a desktop computer, a laptop, or the like. For example, any of nodes 101a-101b and endpoints 102a-102b, as well as monitoring system and interface station 105, may be implemented with computer system 1200 or some variant thereof. In some cases, front-end monitoring probe 205 shown in FIG. 2 may be implemented as computer system 1200. Moreover, one or more of analyzer devices 210 and/or intelligence engine 215 in FIG. 2, eNB 402, MME 403, HSS 404, ODG 405, SGW 406 and/or PGW 407 in FIG. 4, and client 502, server 503, and/or MPs 510a-510n in FIG. 5, may include one or more computers in the form of computer system 1200 or a similar arrangement, with modifications such as including a transceiver and antenna for eNB 502 or omitting external input/output (I/O) devices for MP blades 510a-510n. As explained above, in different embodiments these various computer systems may be configured to communicate with each other in any suitable way, such as, for example, via network 100. Each computer system depicted and described as a single, individual system in the simplified figures and description of this disclosure can each be implemented using one or more data processing systems, which may be but are not necessarily commonly located. For example, as known to those of skill in the art, different functions of a server system may be more efficiently performed using separate, interconnected data processing systems, each performing specific tasks but connected to communicate with each other in such a way as to together, as a whole, perform the functions described herein for the respective server system. Similarly, one or more of multiple computer or server systems depicted and described herein could be implemented as an integrated system as opposed to distinct and separate systems.

As illustrated, computer system 1200 includes one or more processors 1210a-1210n coupled to a system memory 1220 via a memory/data storage and I/O interface 1230. Computer system 1200 further includes a network interface 1240 coupled to memory/data storage and interface 1230, and in some implementations also includes an I/O device interface 1250 (e.g., providing physical connections) for one or more input/output devices, such as cursor control device 1260, keyboard 1270, and display(s) 1280. In some embodiments, a given entity (e.g., network monitoring system 103) may be implemented using a single instance of computer system 1200, while in other embodiments the entity is implemented using multiple such systems, or multiple nodes making up computer system 1200, where each computer system 1200 may be configured to host different portions or instances of the multi-system embodiments. For example, in an embodiment some elements may be implemented via one or more nodes of computer system 1200 that are distinct from those nodes implementing other elements (e.g., a first computer system may implement classification engine 310 while another computer system may implement routing/distribution control module 330).

In various embodiments, computer system 1200 may be a single-processor system including only one processor 1210a, or a multi-processor system including two or more processors 1210a-1200n (e.g., two, four, eight, or another suitable number). Processor(s) 1210a-1210n may be any processor(s) capable of executing program instructions. For example, in various embodiments, processor(s) 1210a-1210n may each be a general-purpose or embedded processor(s) implementing any of a variety of instruction set architectures (ISAs), such as the x86, POWERPC, ARM, SPARC, or MIPS ISAs, or any other suitable ISA. In multi-processor systems, each of processor(s) 1210a-1210n may commonly, but not necessarily, implement the same ISA. Also, in some embodiments, at least one processor(s) 1210a-1210n may be a graphics processing unit (GPU) or other dedicated graphics-rendering device.

System memory 1220 may be configured to store program instructions 1225 and/or data (within data storage 1235) accessible by processor(s) 1210a-1210n. In various embodiments, system memory 1220 may be implemented using any suitable memory technology, such as static random access memory (SRAM), synchronous dynamic RAM (SDRAM), nonvolatile/Flash-type memory, solid state disk (SSD) memory, hard drives, optical storage, or any other type of memory, including combinations of different types of memory. As illustrated, program instructions and data implementing certain operations, such as, for example, those described herein, may be stored within system memory 1220 as program instructions 1225 and data storage 1235, respectively. In other embodiments, program instructions and/or data may be received, sent or stored upon different types of computer-accessible media or on similar media separate from system memory 1220 or computer system 1200. Generally speaking, a computer-accessible medium may include any tangible, non-transitory storage media or memory media such as magnetic or optical media e.g., disk or compact disk (CD)/digital versatile disk (DVD)/DVD-ROM coupled to computer system 1200 via interface 1230.

In an embodiment, interface 1230 may be configured to coordinate I/O traffic between processor 1210, system memory 1220, and any peripheral devices in the device, including network interface 1240 or other peripheral interfaces, such as input/output devices 1250. In some embodiments, interface 1230 may perform any necessary protocol, timing or other data transformations to convert data signals from one component (e.g., system memory 1220) into a format suitable for use by another component (e.g., processor(s) 1210a-1210n). In some embodiments, interface 1230 may include support for devices attached through various types of peripheral buses, such as a variant of the Peripheral Component Interconnect (PCI) bus standard or the Universal Serial Bus (USB) standard, for example. In some embodiments, the function of interface 1230 may be split into two or more separate components, such as a north bridge and a south bridge, for example. In addition, in some embodiments some or all of the functionality of interface 1230, such as an interface to system memory 1220, may be incorporated directly into processor(s) 1210a-1210n.

Network interface 1240 may be configured to allow data to be exchanged between computer system 1200 and other devices attached to network 100, such as other computer systems, or between nodes of computer system 1200. In various embodiments, network interface 1240 may support communication via wired or wireless general data networks, such as any suitable type of Ethernet network, for example; via telecommunications/telephony networks such as analog voice networks or digital fiber communications networks; via storage area networks such as Fiber Channel storage area networks (SANs); or via any other suitable type of network and/or protocol.

Input/output devices 1250 may, in some embodiments, include one or more display terminals, keyboards, keypads, touch screens, scanning devices, voice or optical recognition devices, or any other devices suitable for entering or retrieving data by one or more computer system 1200. Multiple input/output devices 1260, 1270, 1280 may be present in computer system 1200 or may be distributed on various nodes of computer system 1200. In some embodiments, similar input/output devices may be separate from computer system 1200 and may interact with one or more nodes of computer system 1200 through a wired or wireless connection, such as over network interface 1240.

As shown in FIG. 12, memory 1220 may include program instructions 1225, configured to implement certain embodiments or the processes described herein, and data storage 1235, comprising various data accessible by program instructions 1225. In an embodiment, program instructions 1225 may include software elements of embodiments illustrated by FIG. 2. For example, program instructions 1225 may be implemented in various embodiments using any desired programming language, scripting language, or combination of programming languages and/or scripting languages (e.g., C, C++, C#, JAVA, JAVASCRIPT, PERL, etc.). Data storage 1235 may include data that may be used in these embodiments. In other embodiments, other or different software elements and data may be included.

A person of ordinary skill in the art will appreciate that computer system 1200 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations in which elements of different embodiments described herein can be combined, elements can be omitted, and steps can performed in a different order, sequentially, or concurrently.

The various techniques described herein may be implemented in hardware or a combination of hardware and software/firmware. The order in which each operation of a given method is performed may be changed, and various elements of the systems illustrated herein may be added, reordered, combined, omitted, modified, etc. It will be understood that various operations discussed herein may be executed simultaneously and/or sequentially. It will be further understood that each operation may be performed in any order and may be performed once or repetitiously. Various modifications and changes may be made as would be clear to a person of ordinary skill in the art having the benefit of this specification. It is intended that the subject matter(s) described herein embrace all such modifications and changes and, accordingly, the above description should be regarded in an illustrative rather than a restrictive sense. Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method, comprising:
receiving, at a first of two or more processing elements, protocol data units (PDUs) relating to a session on a monitored network, each received PDU marked with a time-ordering sequence reference;
performing, at the first processing element, transaction processing on the received PDUs to generate transaction metadata based upon the received PDUs;
indicating, by any session-owning one of the two or more processing elements, ownership of the session to remaining processing elements within the two or more processing elements;
aggregating, at the session-owning processing element, transaction-processed PDUs relating to the session and associated transaction metadata generated by the transaction processing;
time-ordering, at the session-owning processing element, the aggregated transaction-processed PDUs relating to the session based upon the time-ordering sequence references; and
performing, at the session-owning processing element, session processing on the aggregated, time-ordered transaction-processed PDUs to generate session metadata based upon the received PDUs.

2. The method according to claim 1, wherein the transaction metadata includes at least a number of PDUs for a transaction within the session and the session metadata includes at least a number of transactions for the session.

3. The method according to claim 1, wherein the two or more processing elements are at least one of all mounted on a single printed circuit board and connected by a high-speed data channel.

4. The method according to claim 1, wherein the transaction-processed PDUs and associated transaction metadata are aggregated by the session-owning processing element even if no transaction processing of PDUs relating to the session was performed by the session-owning processing element.

5. The method according to claim 1, further comprising:
when none of the two or more processing elements has advertised ownership of the session, receiving, at one of the two or more processing elements designated as a serializing authority of last resort, at least one of the transaction-processed PDUs and associated transaction metadata; and
assigning, by the serializing authority of last resort processing element, ownership of the session to one of the two or more processing elements.

6. The method according to claim 5, wherein each of the two or more processing elements includes a queue for transaction-processed PDUs and associated transaction metadata relating to any session for which none of the two or more processing elements has advertised ownership.

7. The method according to claim 1, further comprising:
employing two or more systems each configured to receive PDUs relating to communications during network monitoring, wherein one of the two or more systems includes the two or more processing elements.

8. A system, comprising:
two or more processing elements, each processing element configured to receive protocol data units (PDUs) relating to a session on a monitored network and to perform transaction processing on the received PDUs to generate transaction metadata based upon the received PDUs, each received PDU marked with a time-ordering sequence reference,
wherein any session-owning one of the two or more processing elements is configured to advertising ownership of the session to remaining processing elements within the two or more processing elements, and
wherein the session-owning processing element is configured to:
aggregate transaction-processed PDUs relating to the session and associated transaction metadata generated by the transaction processing,
time-order the aggregated transaction-processed PDUs relating to the session based upon the time-ordering sequence references, and
perform session processing on the aggregated, time-ordered transaction-processed PDUs to generate session metadata based upon the received PDUs.

9. The system according to claim 8, wherein the transaction metadata includes at least a number of PDUs for a transaction within the session and the session metadata includes at least a number of transactions for the session.

10. The system according to claim 8, wherein the two or more processing elements are at least one of all mounted on a single printed circuit board and connected by a high-speed data channel.

11. The system according to claim 8, wherein the transaction-processed PDUs and associated transaction metadata are aggregated by the session-owning processing element even if no transaction processing of PDUs relating to the session was performed by the session-owning processing element.

12. The system according to claim 8, wherein, when none of the two or more processing elements has advertised ownership of the session, one of the two or more processing elements designated as a serializing authority of last resort is configured to receive at least one of the transaction-processed PDUs and associated transaction metadata and to assign ownership of the session to one of the two or more processing elements.

13. The system according to claim 12, wherein each of the two or more processing elements includes a queue for transaction-processed PDUs and associated transaction metadata relating to any session for which none of the two or more processing elements has advertised ownership.

14. A network monitor including two or more of the systems according to claim 8, each of the two or more systems configured to receive PDUs relating to communications over the monitored network.

15. A method, comprising:
receiving protocol data units (PDUs) relating to a first session on a monitored network a at a first processing element within a network monitoring system, the first processing element configured to receive indications of ownership of sessions on the monitored network from other processing elements within the network monitoring system;
performing transaction processing on the received PDUs to produce transaction metadata based upon the received PDUs, each received PDU marked with a time-ordering sequence reference, the first processing element including a queue for transaction-processed PDUs and associated transaction metadata relating to any session for which no processing element within the network monitoring system has indicated ownership;
receiving, from a serializing authority of last resort within the network monitoring system, assignment of ownership of the first session to the first processing element; and
when assigned ownership of the first session, the first processing element
aggregates the transaction-processed PDUs relating to the first session and associated transaction metadata,
serializes the aggregated transaction-processed PDUs based upon the time-ordering sequence references, and
performs session processing on the aggregated, serialized transaction-processed PDUs to produce session metadata based upon the PDUs.

16. The method according to claim 15, wherein the transaction metadata includes at least a number of PDUs for a transaction within the session and the session metadata includes at least a number of transactions for the session.

17. The method according to claim 15, wherein the first processing element is one of two or more processing elements each configured to receive at least some of the PDUs relating to the session and to perform transaction processing on the received PDUs.

18. The method according to claim 17, wherein the two or more processing elements are at least one of all mounted on a single printed circuit board and connected by a high-speed data channel.

19. The method according to claim 17, each of the two or more processing elements includes a queue for transaction-processed PDUs and associated transaction metadata relating to any session for which no processing element within the network monitoring system has advertised ownership.

20. The method according to claim 15, wherein the first processing element includes the serializing authority of last resort.
